(19) United States
(12) Patent Application Publication
(10) Pub. No.: US 2012/0179620 A1
(43) Pub. Date: Jul. 12, 2012

(54) METHOD AND APPARATUS FOR TIMED MOBILE DELIVERY OF VIRTUAL GOODS AND PHYSICAL GOODS

(76) Inventors: SANDY FLIDERMAN, ALBERTSON, NY (US); BRIAN A. FERRARA, LONG BEACH, NY (US)

(21) Appl. No.: 13/310,740

(22) Filed: Dec. 3, 2011

Related U.S. Application Data
(60) Provisional application No. 61/419,723, filed on Dec. 3, 2010.

(51) Int. Cl. G06Q 50/28

(52) U.S. Cl. 705/332

(57) ABSTRACT

A method for timed mobile delivery of goods comprises providing a user interface to a mobile device. The user interface allows the user of the mobile device to input a data file that provides log-in data, creates a new timed deliverable, selects a delivery format, template, and recipient for the deliverable, inputs a message to accompany the deliverable, and selects a gifting option and delivery date and time. The user interface sends the data file from the mobile device to a computer at a remote location. The method further comprises receiving the data file from the mobile device at the remote computer, storing and processing the data, and creating a timed mailer using the data. The method checks to determine if the delivery time and date is reached; and if so, triggers the timed mailer sending the timed deliverable to the designated recipient.

### CROSS-REFERENCE TO RELATED APPLICATIONS

This application claims benefit of U.S. Provisional Application No. 61/419,723, filed Dec. 3, 2010, and entitled PROCESS FOR TIME-BASED DIGITAL GIFT SENDING.

### TECHNICAL FIELD

The invention relates to a method and apparatus for timed delivery of virtual goods and/or physical goods for users of mobile devices. In particular, it relates to a method and apparatus for sending a virtual or physical gift to or from the user of a mobile device to be scheduled in advance of the desired time of delivery.

### SUMMARY

An apparatus and method are provided to allow users with mobile devices to send digital gifts that will be received at a date and time the user pre-determines either on an individual gift basis or can be setup for a group of recipients. The user selects an image and/or message on their mobile device and then selects the specific gift or gifts that will be sent to the recipient(s). The gifts may be virtual gifts (e.g., images or digital representations of objects) and/or physical gifts. Once the user has completed this procedure, the apparatus will arrange for delivery of the image/message/gift to the designated recipient(s) at the predetermined date and time designated by the user.

In one embodiment, a method for timed mobile delivery of goods comprises providing a user interface to a mobile device of a customer. The user interface allows the customer to use the mobile device to input data file that provides customer log-in data, creates a new timed deliverable, selects a delivery format from a plurality of delivery formats, selects a template from a plurality of templates, selects at least one recipient for the deliverable and inputs a message to accompany the deliverable, selects a gifting option and selects a delivery date and time. The user interface further sends the input data file from the mobile device to a computer at a remote location. The method further comprises the step of receiving the input data file from the mobile device of the customer at the computer at the remote location, storing the data from the input data file, processing the data from the input data file, and creating a timed mailer using the data from the input data file. The method further checks to determine if the delivery time and date is reached, triggering the timed mailer when user-defined date/time is reached, and sending the timed deliverable to the designated recipients.

In another embodiment, an apparatus for timed mobile delivery of goods comprises a computer system including a central processing unit, a memory unit, an input/output device and a network interface. The network interface is connectable to a packet network such that the computer system can communicate with mobile devices connected to the packet network. The memory unit includes instructions to perform operations including providing a user interface to a mobile device of a customer. The user interface allows the customer to use the mobile device to input a data file that provides customer log-in data, creates a new timed deliverable, selects a delivery format from a plurality of delivery formats, selects a template from a plurality of templates, selects at least one recipient for the deliverable and inputs a message to accompany the deliverable, selects a gifting option and selects a delivery date and time. The apparatus receives the input data file from the mobile device of the customer, stores the data from the input data file, processes the data from the input data file and creates a timed mailer using the data from the input data file. The apparatus checks to determine if the delivery time and date is reached, triggering the timed mailer when user-defined date/time is reached and sending the timed deliverable to the designated recipient.

### BRIEF DESCRIPTION OF THE DRAWINGS

For a more complete understanding, reference is now made to the following description taken in conjunction with the accompanying Drawings in which:

FIG. 1 illustrates an apparatus for timed mobile delivery in accordance with one embodiment; and

FIGS. 2-6 illustrate a method for timed mobile delivery in accordance with another embodiment.

### DETAILED DESCRIPTION

Referring now to the drawings, wherein like reference numbers are used herein to designate like elements throughout, the various views and embodiments of a process for time-based digital gift sending are illustrated and described, and other possible embodiments are described. The figures are not necessarily drawn to scale, and in some instances the drawings have been exaggerated and/or simplified in places for illustrative purposes only. One of ordinary skill in the art will appreciate the many possible applications and variations based on the following examples of possible embodiments.

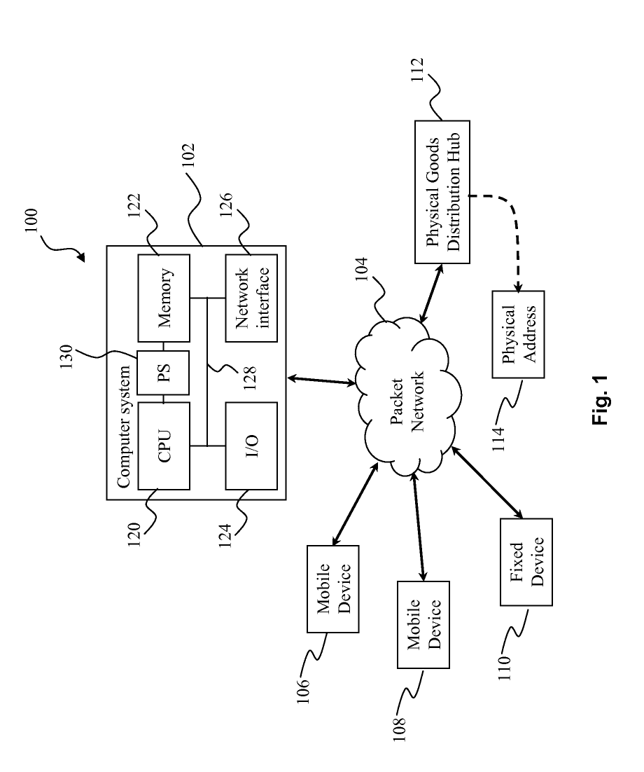

Referring now to FIG. 1, there is illustrated an apparatus for timed mobile delivery of virtual goods and physical goods in accordance with one embodiment. The apparatus 100 includes a computer system 102 as further described below that is connected to a packet network 104, e.g., the Internet or other global communications network. By means of the packet network 104, the computer system 102 may communicate (i.e., exchange data) with various mobile devices 106, 108, which may be mobile phones, smart phones (e.g., phones using the Apple® iOS operating system such as iPhone®, Google® Android® operating system, Microsoft® Windows® operating system, RIM® Blackberry® operating systems or other mobile operating systems), tablet computers (e.g., Apple® iPad®), PDA devices or other web-enabled devices (e.g., Apple® iPod Touch® devices). The communication between the mobile devices 106, 108 and the packet network 104 may be accomplished by cellular radio technology (e.g., CDMA, GSM or other cellular data communications protocols), by localized Wi-Fi® radio technology (e.g., IEEE 802.11 communication protocols) or other wireless communication technology. By means of the packet network 104, the computer system 102 may also communicate with fixed devices 110 such as personal computers. A distribution hub 112 for physical goods may also be connected to the packet network 104 such that the computer system 102 can communicate orders for physical goods to the distribution hub. From the distribution hub 112, physical goods may be delivered (denoted by the dashed line) to a physical address 114, regardless of whether the physical address has access to the packet network 104.

Referring still to FIG. 1, one embodiment of a computer system 102 is illustrated. The computer system 102 is one possible example of a system component or device such as an endpoint, an access server, or a media server. The computer system 102 may include a central processing unit (“CPU”) 120, a memory unit 122, an input/output (“I/O”) device 124, and a network interface 126. The components 120, 122, 124 and 126 are interconnected by a transport system (e.g., a bus) 128. A power supply (PS) 130 may provide power to components of the computer system 102, such as the CPU 120 and memory unit 122. It is understood that the computer system 102 may be differently configured and that each of the listed components may actually represent several different components. For example, the CPU 120 may actually represent a multi-processor or a distributed processing system; the memory unit 122 may include different levels of cache memory, main memory, hard disks, and remote storage locations; the I/O device 124 may include monitors, keyboards, touch-screens, touch-pads and the like; and the network interface 126 may include one or more network cards providing one or more wired and/or wireless connections to the packet network 104. Therefore, a wide range of flexibility is anticipated in the configuration of the computer system 102.

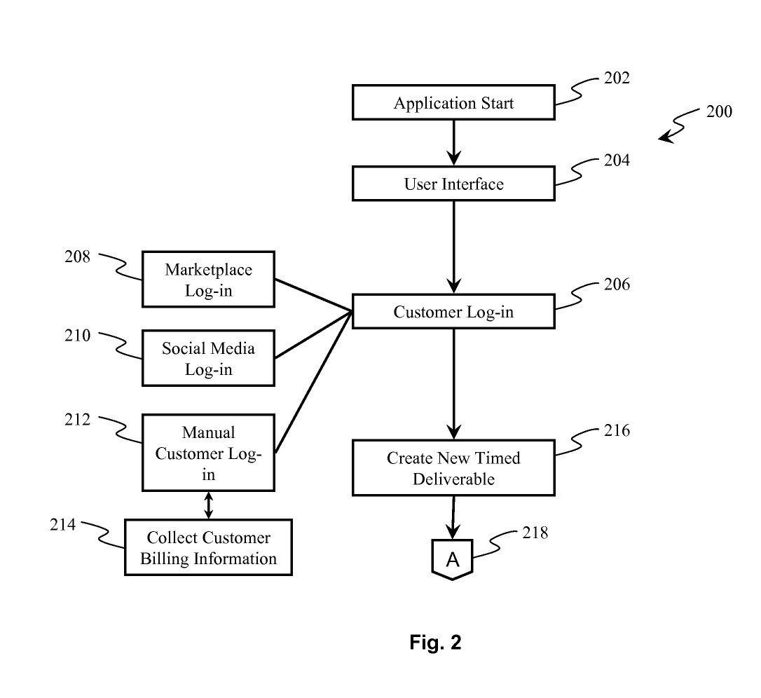

The computer system 102 may use any operating system (or multiple operating systems), including various versions of operating systems provided by Microsoft (such as WINDOWS®), Apple (such as Mac OS X®), UNIX, and LINUX, and may include operating systems specifically developed for handheld devices, personal computers, and servers depending on the use of the computer system 102. The operating system, as well as other instructions (e.g., for all or part of the method of FIGS. 2-6), may be stored in the memory unit 122 and executed by the processor 120. For example, the memory unit 122 of the computer system 102 may include instructions for performing functions as described herein with respect to the various embodiments illustrated in sequence diagrams and flowcharts.

Referring now to FIGS. 2-6, there is illustrated a method for timed mobile delivery of virtual goods and physical goods in accordance with another embodiment. The method 200 may be implemented on an apparatus such as apparatus 100 of FIG. 1. The method 200 comprises steps and operations as follows.

Referring specifically to FIG. 2, the method 200 starts by providing a user interface to a mobile device (e.g., 106, 108) of a customer. The user interface is typically provided as part of an application (or “app”) that may be provided directly by the computer system 100. Alternatively, the application may be provided indirectly, e.g., via an “App Store” or other application download site. The customer installs the application on the mobile device and then starts the application (block 202) to launch the user interface (block 204). The user interface allows the customer to use the mobile device to input data file that provides customer log-in data (block 206). The log-in data may include information regarding previous registrations by the customer, e.g., to a third-party marketplace (block 208) such as GOOGLE MarketPlace or Amazon Prime® or to a social media organization (block 210) such as FaceBook® or Twitter®, such that the customer's billing information is already known. Alternatively, the customer can manually log-in (block 212) and the user interface will collect the customer's billing information (block 214). Next, the user interface creates a new timed deliverable (block 216), which is a data file designating the type of goods to be delivered to a recipient and other relevant data.

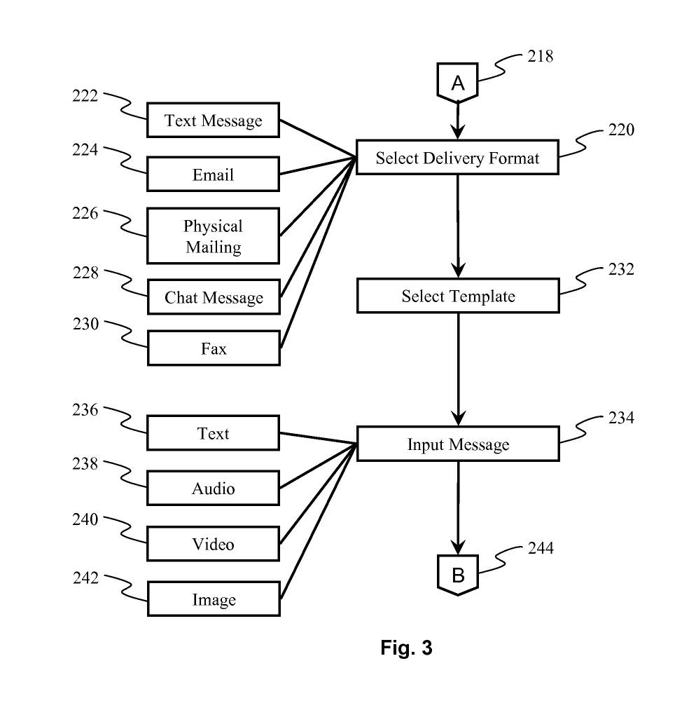

Referring now to FIG. 3, the user interface next allows the customer to selects a delivery format from a plurality of delivery formats (block 220). The delivery formats may be text message (block 222), email (block 224), physical mail (226), chat message (228) and fax (230). This information becomes part of the timed deliverable.

Next, the user interface allows the customer to selects a goods template from a plurality of templates (block 232). A template is a pre-populated configuration for a particular type of goods. For example, a template may reflect goods directed to a similar theme such as birthday, anniversary, season, holiday or other category. Within each template, a selection of different goods may be offered, but each will be directed to the selected theme of the template. This information becomes part of the timed deliverable.

Next the user interface allows the customer to select at least one recipient for the deliverable and input a message to accompany the deliverable (block 234). The selection of recipients may be performed by accessing the “contacts” data information already located on the customer's mobile device, or the recipient data may be inputted manually. The message may be input in the form of text (block 236), audio (block 238), video (block 240) and/or image (block 242). This information becomes part of the timed deliverable.

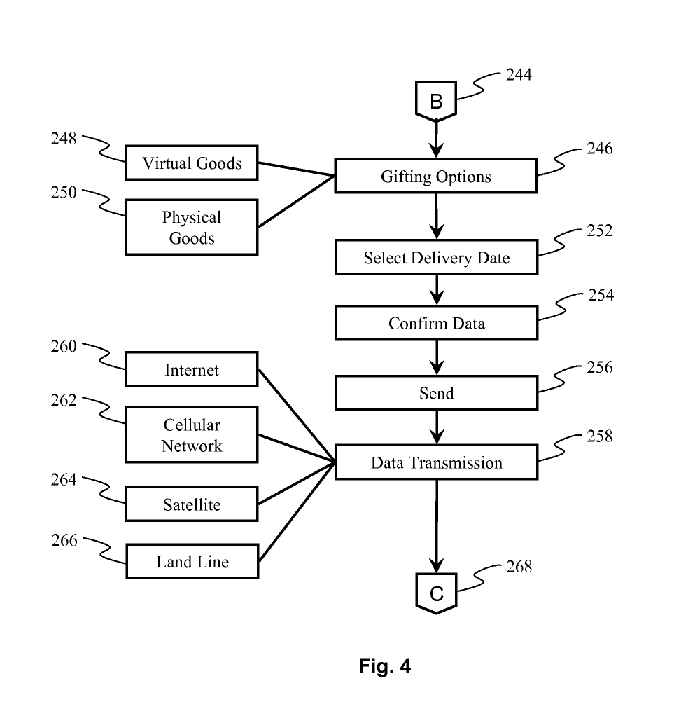

Referring now to FIG. 4, the user interface next allows the customer to select a gifting option (block 246). The gift may be virtual goods (block 248) and/or physical goods (block 250). This information becomes part of the timed deliverable. Next the user interface allows the customer to select a delivery date and time (block 252). This information becomes part of the timed deliverable.

Next, the user interface may allow the customer to confirm the data that has been input (block 254). The data is then sent by the user interface from the mobile device (e.g., devices 106, 108) to a computer system (e.g., system 102), which may be at a remote location. The data transmission (block 258) may be performed by internet (block 260), cellular network (262), satellite (264) and/or land line communications (block 266).

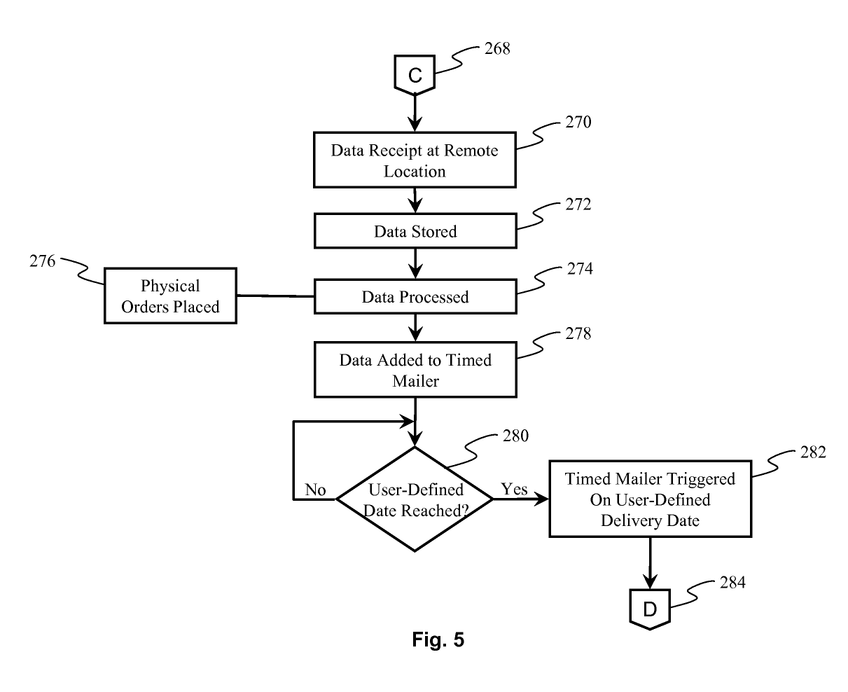

Referring now to FIG. 5, at the computer system, the input data file from the mobile device of the customer is received (block 270). Next, the data from the input data file is stored (block 272) and processed (block 274). If a physical gift is designated, a physical order may be placed (block 276), e.g., to a physical distribution hub (e.g., hub 112).

Next, a timed mailer is created (block 278) using the data from the input data file. Once this occurs, the method checks to determine if the delivery time and date is reached (block 280). The method triggers the timed mailer when user-defined date/time is reached (block 282).

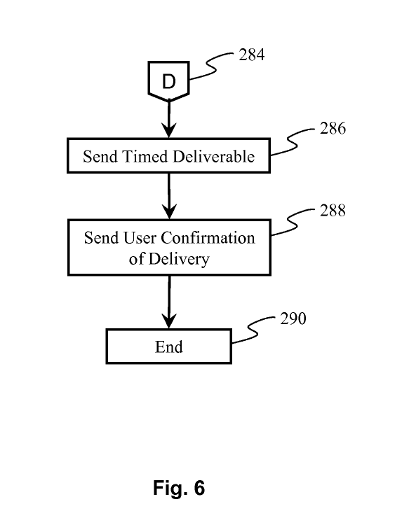

Referring now to FIG. 6, the timed deliverable is sent to the designated recipients (block 286). Optionally, the method may check for confirmation of delivery to the recipient(s) and provide confirmation back to the customer (block 288).

It should be understood that the drawings and detailed description herein are to be regarded in an illustrative rather than a restrictive manner, and are not intended to be limiting to the particular forms and examples disclosed. On the contrary, included are any further modifications, changes, rearrangements, substitutions, alternatives, design choices, and embodiments apparent to those of ordinary skill in the art, without departing from the spirit and scope hereof, as defined by the following claims. Thus, it is intended that the following claims be interpreted to embrace all such further modifications, changes, rearrangements, substitutions, alternatives, design choices, and embodiments.

1. A method for timed mobile delivery of goods, the method comprising the following steps:
providing a user interface to a mobile device of a customer, the user interface allowing the customer to use the mobile device to input data file that
provides customer log-in data,
creates a new timed deliverable,
selects a delivery format from a plurality of delivery formats,
selects a template from a plurality of templates,
selects at least one recipient for the deliverable and inputs a message to accompany the deliverable,
selects a gifting option and
selects a delivery date and time;
the user interface further sending the input data file from the mobile device to a computer at a remote location;
receiving the input data file from the mobile device of the customer at the computer at the remote location;
storing the data from the input data file;
processing the data from the input data file;
creating a timed mailer using the data from the input data file;
checking to determine if the delivery time and date is reached;
triggering the timed mailer when user-defined date/time is reached; and
sending the timed deliverable to the designated recipients.

2. The method for timed mobile delivery of claim 1, wherein:
the user interface collects billing information from the customer; and
the user interface includes the billing information in the customer log-in data.

3. The method for timed mobile delivery of claim 1, wherein the plurality of delivery formats provided by the user interface includes at least two of the following formats:
text message;
email;
physical mail;
chat message; and
fax.

4. The method for timed mobile delivery of claim 1, wherein the user interface allows messages of the following message types to be input by the customer:
text content;
audio content;
video content; and
image content.

5. The method for timed mobile delivery of claim 1, wherein the user interface allows the user to select between gifting options including virtual goods and physical goods.

6. The method for timed mobile delivery of claim 1, wherein the sending of the input data file from the mobile device to a computer at a remote location is performed by one of the following:
Internet communication;
cellular network communication;
satellite communication; and
telephone land line.

7. The method for timed mobile delivery of claim 1, further comprising:
sending an order for physical goods to a distribution hub; and
delivering physical gift to a physical address.

8. The method for timed mobile delivery of claim 1, further comprising sending confirmation of delivery of the deliverable to the mobile device of the customer.

9. An apparatus for timed mobile delivery of goods, the apparatus comprising:
a computer system including a central processing unit, a memory unit, an input/output device and a network interface;
the network interface being connectable to a packet network such that the computer system can communicate with mobile devices connected to the packet network;
the memory unit including instructions to perform operations including
providing a user interface to a mobile device of a customer, the user interface allowing the customer to use the mobile device to input data file that
provides customer log-in data,
creates a new timed deliverable,
selects a delivery format from a plurality of delivery formats,
selects a template from a plurality of templates,
selects at least one recipient for the deliverable and inputs a message to accompany the deliverable,
selects a gifting option and
selects a delivery date and time;
receiving the input data file from the mobile device of the customer;
storing the data from the input data file;
processing the data from the input data file;
creating a timed mailer using the data from the input data file;
checking to determine if the delivery time and date is reached;
triggering the timed mailer when user-defined date/time is reached; and
sending the timed deliverable to the designated recipients.

10. The apparatus for timed mobile delivery of claim 9, wherein the user interface allows the user to select between gifting options including virtual goods and physical goods.

11. A system for the timed mobile delivery of physical or virtual goods to and from mobile devices connected to a packet network, the system comprising:
a computer system including a central processing unit, a memory unit, an input/output device and a network interface;
the network interface being connectable to a packet network such that the computer system can communicate with mobile devices connected to the packet network;
the memory unit including a plurality of instructions stored therein, the plurality of instructions including application instructions transferrable via the network interface to a mobile device, the application instructions including for displaying a user interface on the mobile device;
a mobile device capable of receiving the application instructions transferred from the computer system, the application instructions being executable on the mobile device,
wherein execution of at least a first portion of the application instructions causes the mobile device to display a user interface to a user, the user interface allowing the user to input a data file and the data file including customer log-in data,
wherein execution of at least a second portion of the application instructions on the mobile device allows the user to create a new timed deliverable,
wherein execution of at least a third portion of the application instructions on the mobile device allows the user to select a delivery format from a plurality of delivery formats,
wherein execution of at least a fourth portion of the application instructions on the mobile device allows the user to select a template from a plurality of templates,
wherein execution of at least a fifth portion of the application instructions on the mobile device allows the user to select at least one recipient for the deliverable and inputs a message to accompany the deliverable,
wherein execution of at least a sixth portion of the application instructions on the mobile device allows the user to selects a gifting option and
wherein execution of at least a seventh portion of the application instructions on the mobile device allows the user to selects a delivery date and time;
the computer system configured to receive the input data file from the mobile device and execute additional instructions from the plurality of instructions stored in the memory unit;
wherein execution of at least a first portion of the additional instructions on the computer system allows storing the data from the input data file in the memory unit;
wherein execution of at least a second portion of the additional instructions on the computer system allows processing the data from the input data file;
wherein execution of at least a third portion of the additional instructions on the computer system allows creating a timed mailer using the data from the input data file;
wherein execution of at least a fourth portion of the additional instructions on the computer system allows checking to determine if the delivery time and date is reached;
wherein execution of at least a fifth portion of the additional instructions on the computer system allows triggering the timed mailer when user-defined date/time is reached; and
wherein execution of at least a sixth portion of the additional instructions on the computer system allows sending the timed deliverable to the designated recipients.

12. The system for timed mobile delivery of claim 11, wherein:
the user interface on the mobile device collects billing information from the customer; and
the user interface includes the billing information in the customer log-in data.

13. The system for timed mobile delivery of claim 11, wherein the plurality of delivery formats provided by the user interface on the mobile device includes at least two of the following formats:
text message;
email;
physical mail;
chat message; and
fax.

14. The system for timed mobile delivery of claim 11, wherein the user interface on the mobile device allows messages of the following message types to be input by the user:
text content;
audio content;
video content; and
image content.

15. The system for timed mobile delivery of claim 11, wherein the user interface on the mobile device allows the user to select between gifting options including virtual goods and physical goods.

16. The system for timed mobile delivery of claim 11, wherein the sending of the input data file from the mobile device to a computer at a remote location is performed by one of the following:
Internet communication;
cellular network communication;
satellite communication; and
telephone land line.

17. The system for timed mobile delivery of claim 11, further comprising:
sending an order for physical goods to a distribution hub; and
delivering physical gift to a physical address.
